(19) United States
(12) Patent Application Publication
(10) Pub. No.: US 2025/0129988 A1
(43) Pub. Date: Apr. 24, 2025

(54) METHOD OF HEAT-TREATING TUBING

(71) Applicant: Plymouth Tube Co., Warrenville, IL (US)

(72) Inventors: Nicholas L. Bugliarello-Wondrich, Campton Hills, IL (US); Daniel William Klein, Eagle, WI (US)

(21) Appl. No.: 18/921,284

(22) Filed: Oct. 21, 2024

Related U.S. Application Data
(60) Provisional application No. 63/545,279, filed on Oct. 23, 2023.

(51) Int. Cl. F27D 7/06; F27D 3/00; F27D 3/02

(52) U.S. Cl. CPC F27D 7/06; F27D 3/0024; F27D 3/022; F27D 2007/066; F27M 2001/1556

(57) ABSTRACT

A method of heat-treating tubing is disclosed which obtains desired performance characteristics, and more particularly to a method of heat-treating tubing which minimizes undesirable tinting and oxidation of the interior surfaces of tubing during heat-treatment by controlling the atmosphere within the tubing. This is achieved by purging the interior of the tubing with an inert gas, or a like protective atmosphere, as the tubing is advanced into an associated heat-treatment furnace. Notably, the purging is effected via the trailing ends of the tubing as it introduced into the heat-treatment furnace. Additionally, the method contemplates that a vacuum can be applied to the interior of the tubes during treatment in order to draw the protective atmosphere within the furnace into the leading ends of the tubing.

### CROSS-REFERENCE TO RELATED APPLICATIONS

This application is a non-provisional, which claims priority of Provisional Application Ser. No. 63/545,279 filed Oct. 23, 2023, the disclosure of which is hereby incorporated by reference in its entirety.

### FIELD OF THE INVENTION

The present invention relates generally to methods of heat-treating tubing to obtain desired performance characteristics, and more particularly to a method of heat-treating tubing which minimizes undesirable tinting and oxidation of the interior surfaces of tubing during heat-treatment by controlling the atmosphere within the tubing, including purging the interior of the tubing with an inert gas, or a like protective atmosphere. For some applications, a reducing gas such as hydrogen may be used for purging.

### BACKGROUND OF THE INVENTION

A common way to heat-treat steel, stainless steel and nickel alloy tubing is to use bright annealing. A bright anneal furnace is designed with a muffle or sealed furnace shell that maintains a protective and/or reducing gas around the tubing to prevent oxidation. These furnaces are often continuous, meaning that the tubing enters one end of the furnace, is then heated to a desired temperature and then cooled while still in the protective gas. The tubing is transported by either rolls or belt. A positive pressure inside the furnace is maintained by curtains at both ends. For the protective gas to enter the tube's internal diameter (I.D.) the positive pressure helps to purge the tube's I.D. as it moves through the curtain.

Having tinted or oxidized inside diameters (IDs) of tubes after heat treatment is a large concern when processing tubing to tight standards. This issue is particularly troublesome on small I.D. tubing (≤0.632″ O.D.) and can cause additional process steps, scrap or rejections by the customer. Furthermore, this defect can force the need for additional expensive corrective processes such as pickling and rinse operations. Scrap, rework and the need for additional processes all can be prohibitively costly to the manufacturing process.

The individual or combined effects of oxygen, moisture or contaminants on I.D. tube surfaces can be detrimental if present during the high temperature annealing process. If tinting or heavier oxides form, then the ability of the tube to remain ‘stainless’ decreases due to a chrome oxide formation which results in chromium depletion in the sub-surface layer. This chromium depletion increases its susceptibility to corrosion. The outside diameter surface is easier to keep from detrimental effects with a properly set up furnace that has free atmosphere flow around the tubes. As the tube I.D. gets smaller or the tubes get longer, it is more difficult for the furnace atmosphere to push the atmosphere inside the tubes to remove these contaminants. The atmosphere takes the path of least resistance when exiting the furnace atmosphere going around the tubes rather in the tubes. Under the small I.D. and longer tube scenario, furnace pressure is insufficient to fully purge the tubes in a reasonable period of time.

The smaller the inside diameter (I.D.) of the tubes and the longer the tubes, the more prone they are to tinting or heavier oxidation of the I.D. during heat treatment. Normally the pressure of the furnace atmosphere that is generated by a combination of gas flow and sealing methods at the entrance and exit are the sole methods of assuring the protective gases reach all surfaces of the tubes. With smaller I.D. tubes, the furnace protective atmosphere gas takes much longer to purge oxygen from the tubes. Similar sizing concerns are evident in other processes such as alkaline cleaning, blowing media through the tube to clean the I.D.'s and drying operations. This all translates to the smaller I.D. tubes being more susceptible to cleaning and drying issues, as well as increasing the need for improved purging during the heat-treatment cycle.

If tinted or oxidized, the tube's I.D. often doesn't meet customer standards and specifications. Most industries require a bright, clean I.D. free of any tint. Some of these industries include: aircraft, aerospace, petrochemical, pharmaceutical, medical and ultra clean applications, as well as thermocouple clean applications.

In the past, tube manufacturers that purge oxygen from inside of tubes generally purge by pumping an inert gas into the leading edge of the tubes before running them into the furnace. This can be done individually or in groups of tubes. This process can be inefficient and ineffective since the purge gas does not remain in the tube and may be replaced with ambient air.

State-of-the-art technology to combat this tinting issue has been to push out oxygen from the tubes and usually away from the furnace. This can be done with gases such as (but not limited to) nitrogen, argon, hydrogen and dissociated ammonia. Some purge setups allow for all tubes to be purged at once, but more often they are purged individually or in small groups. When purging tubes one at a time or in small groups, there is a variation from when the first tubes are purged to when the last tubes are purged before entering the furnace. Sometimes end caps are used to keep the inert gases in. Unless two people are performing the purge operation in concert, oxygen can be trapped inside the tubes due to human error. Sometimes the end caps are put on the trailing end of the tubes so oxygen can still enter the leading end of the tubes after purging and before the tubes reach the furnace entrance. All these methods are not very dependable or repeatable due to the high degree of operator interaction required, inconsistencies in the method, variation in purging times, variation in time from when purged to when tubes start entering the furnace and variation in the environment around the furnace.

Additionally, these methods don't work equally well on all sizes and lengths for the following reasons:
Some gases used dissipate faster than others,
ID dimension and tube length effect purge gas flow rate, and
Operational steps and setups are often unacceptably inefficient.
   These concerns all contribute to difficulty in maintaining purge gas inside the tubes until they can enter the furnace.

There are many high temperature furnace curtain designs to help seal the entry and exit of the furnaces. These curtains are designed to keep oxygen out and force atmosphere into the tubes by building a positive pressure in the furnace. This is effective to a certain degree but drops off as the tube's I.D. get smaller and the tubes' length get longer. For example, furnace atmospheric pressure can be effective in preventing tinting of tubes of ¾″ diameter or larger, but less and less effective as the I.D. decreases and the length increases. There is a method used to push higher pressure atmosphere gas towards the ends of the tubes using a sparger in the furnace either in the entry tunnel or in the furnace heat box. This may help but with the smaller ID tubes, the amount of time the ends of the tubes are close to the sparger is not sufficient to push all the oxygen out of the tubes. Further, there is still the tendency for the gases to flow around instead of into the I.D. of the tube and create difficulties balancing the flow of atmosphere gases exiting the entry and exit of the furnace.

Tinted tube I.D.'s cause rejections, rework, remakes and have forced added preventative and rework processes such as pickling and rinse operations. By way of example, one prominent mill experienced over $454,000 in costs due to tinted ID's during the course of 12 months of operation.

During invention development, applicants investigated previous efforts to limit undesired tinting of tubing during heat-treatment. This investigation showed that such efforts were of limited effectiveness, and frequently resulted in inconsistent results. One such effort, believed to have been tried about 20 years ago, is believed to have been operated by providing an arrangement that was clamped over the ends of the tubes. It is uncertain if the arrangement could be used for a full layer/load of tubes, and it is not certain if a cup, two strips with rubber seals, or a box was clamped onto the tubes, but it is believed the arrangement included a rubber cup with possibly a hose-clamp securement. It is understood that users would pump hydrogen into the leading end of the tubes (the end of the tubes that goes into the furnace first). The arrangement would run a timed cycle for this, purging the tubes with hydrogen, and it is believed that cup would then be removed from the tubes, and a programmable logic controller (PLC) would purge the hoses with nitrogen. Subsequently, the tubes would be run up to the heat-treating furnace, losing most if not all of the hydrogen in the approximately three-foot gap running the tubes fast up to the furnace belt, and approximately four feet the tubes then had to run at the furnace belt speed before getting into the furnace, and run their cycle.

Another application was operated off of a timer to provide a seven-second purge time, run three times for each small group of tubes, prior to discontinuation of the use of the method, due to sporadic issues. Initially, this application was run at seven seconds, then trialed at a twenty-one second purge time.

As will be further discussed, the present invention has proved to be far superior to this in many ways, including: ease of operator use; and important features, including diagnostics checking sealing effectiveness, negligible chance of short or miss purge cycle and effectiveness of the purging. Notably the present purging cycle brings the leading edge of the tubes into the furnace so there is no loss of atmosphere; if the tubes get purged but don't get advanced into the furnace right away, the chamber stays closed maintaining the atmosphere and the atmosphere gets ‘bumped’ when the leading end of the tubes get to a first light curtain, then are timed to purge right as the tubes get to the flame curtain as they go into the furnace; furnace atmosphere is purged from the chamber using inert gas as chamber opens. “Operator friendly” operation is achieved—all the complication went into the system, with the operator ergonomics and time reduced.

While previous efforts have employed a control panel, and an associated PLC for timing the pushing of hydrogen into the tubes and then purging the hydrogen out of their hose after the timed purge cycle, such arrangements proved to be of limited effectiveness due to time between purge and entry into furnace, even though it is believed the practice may have included grouping some or all of the tubes in a layer/load together for a purge cycle.

Other previous attempts to limit tinting during heat-treatment are believed to have included a sparger system that would blow furnace atmosphere into the tubes as they went under it. However, the short time under the sparger, and the difficulties with not creating a venturi inside the furnace and pulling air in from the other end of the furnace, detracted from the appeal of this method.

### SUMMARY OF THE INVENTION

In accordance with the present invention, a method of heat-treating tubing contemplates minimizing the effects of tinting and like oxidation on tubing during heat-treatment, particularly at the inside surfaces of the tubing. Notably, this is achieved by controlling the atmosphere within the tubing by purging the interior of the tubing with protective atmosphere such as an inert gas during heat-treatment or immediately prior to heat-treatment. The present method employs a purge sled which is operatively connected with the tubing at the trailing ends thereof, and which introduces the inert gas into the interior of the tubing during treatment. while the maintaining the protective atmosphere in the tubes during heat-treatment. In the preferred practice, the purge sled can be operated to create a vacuum which acts to the draw the atmosphere within the heat-treatment furnace into the tubing, thereby maintaining the desired atmosphere within the tubing throughout the heat-treatment process.

Thus, the present invention provides a purge system for tubing or pipes to prevent inside diameter oxidation, which can be readily employed for treatment of a wide range of tubing sizes.

The present method of heat-treating tubing comprises the steps of providing a heat-treatment furnace having a controlled internal atmosphere, and providing one or more metallic tubes for heat-treatment. The present method contemplates that a purge sled is provided, wherein the purge sled has a gas chamber for receiving a trailing end of each of the metallic tubes. The trailing end of each metallic tube is sealed in gas-tight relationship with the gas chamber of said purge sled for control of the atmosphere within the metallic tubes.

In order to purge the interior of the tubing being heat-treated, the gas chamber of the purge sled is pressurized with a protective atmosphere such as an inert gas to thereby purge the inside diameter of each of the metallic tubes. The protective atmosphere desirably acts to minimize oxidation or degradation of the inside diameter of each of the metallic tubes. The purging of the tubing is maintained while advancing the purge sled, to thereby advance the metallic tubes into the heat-treatment furnace. Effectiveness is enhanced by monitoring pressure within the gas chamber of the purge sled to ascertain that the gas chamber is sufficiently sealed to the trailing ends of the metallic tubes to purge the inside diameter of each one of the metallic tubes. Desirably, the present method can be operated to purge the inside diameter of the tubing with minimal disruption to the normal balance and flow of atmosphere gases at the entry and exit of the heat-treatment furnace.

It is within the purview of the present invention to further control the atmosphere within the metallic tubing by providing another purge sled for operative connection with the leading ends of the tubes being treated for very long tubes once they exit the furnace. A gas chamber within the further sled can be operated to maintain the desired atmosphere within the tubes as the tubes move out from within the atmosphere of the heat-treating furnace. Thus, for those applications in which both leading and trailing ends of the tubing are outside of the furnace, purge sleds can be provided at both ends of the tubing.

In the preferred practice of the present invention, purging of the tubing can be enhanced by creating a vacuum within the gas chamber of the purge sled after previously pressurizing the gas chamber of the purge sled. This acts to thereby draw the controlled internal atmosphere of the heat-treating furnace into a leading end of each of the metallic tubes, and into the inside diameter of each said metallic tube. Notably, this step of creating a vacuum within the gas chamber of the purge sled includes creating a venturi to generate a vacuum within the gas chamber of the sled.

The effectiveness of the present method is enhanced by monitoring pressure of compressed air for creating the venturi to create the vacuum within the purge sled gas chamber, to thereby determine that sufficient gas pressure exists to create the venturi effect with sufficient vacuum to aspirate and draw the controlled internal atmosphere of the heat-treatment furnace into the inside diameter of each one of the metallic tubes. Effectiveness is further enhanced by providing an accumulator tank for creating the venturi for consistent vacuum operation.

Efficient operation is further promoted by: (1) determining variations in the lengths of the metallic tubes to ensure sufficient purging of longer ones of said metallic tubes; (2) determining the internal diameter of the metallic tubes to ensure sufficient purging of longer and smaller diameter metallic tubes; and (3) monitoring the number of the metallic tubes subject to purging to evaluate overall heat-treatment production.

In the preferred practice, the present method includes providing a pair of spaced apart sensors to determine if the metallic tubes are present, and if the metallic tubes are starting in or going out of the sensor zone, and to further determine the speed at which the tubes are advanced into the heat-treatment furnace. To this end, two light curtains are employed for the logic controller for “seeing” if tubes are present, and if they are starting in or going out of the sensor zone, and to also obtain timing to determine how fast the belt advancing the tube is running. This is important for determining when the system is operated for pulling of the furnace atmosphere into the tubes, to avoid drawing air, and flame, in addition to hydrogen into the purge chamber. This belt or roll speed timing can also be provided by the PLC employed for operating the heat-treatment furnace.

Thus, the present invention provides a purge system for tubing or pipes to prevent inside diameter oxidation, which can be readily employed for treatment of a wide range of tubing sizes.

Other features and advantages of the present invention will be readily apparent from the following detailed description, the accompanying drawings, and the appending claims.

### BRIEF DESCRIPTION OF THE DRAWINGS

FIG. 1 is a diagrammatic view of a heat-treating apparatus for practicing the method of the present invention;

FIG. 2 is a diagrammatic view of a purge sled for practicing the method of the present invention;

FIG. 3 is a further diagrammatic view of the purge sled for practicing the present invention;

FIG. 4 is a diagrammatic view of an embodiment of the purge sled shown in an open condition for receiving tubing to be heat-treated; and

FIG. 5 is a photograph showing the interior of two different metallic tubes to illustrate undesired tinting of one of the tubes.

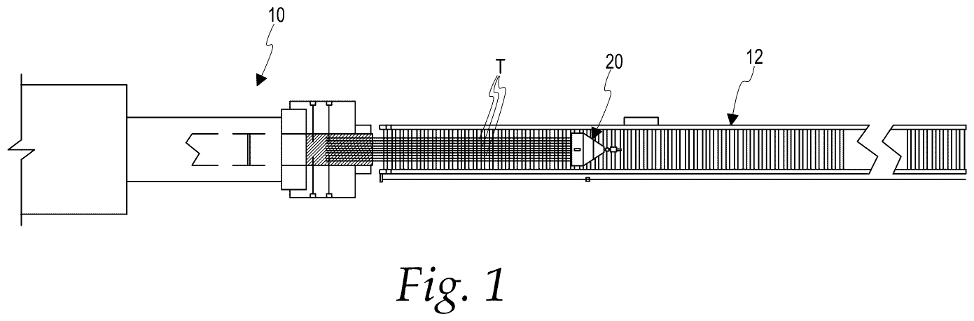

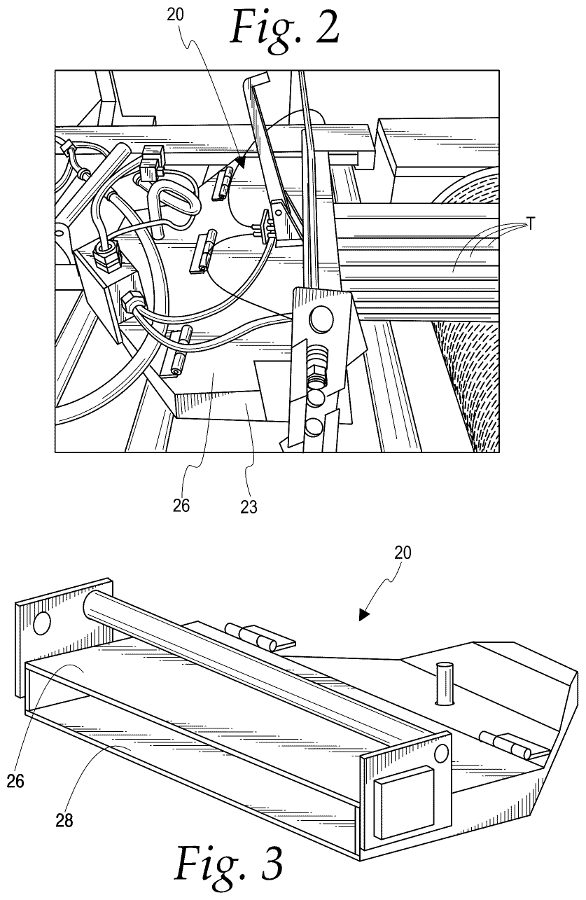

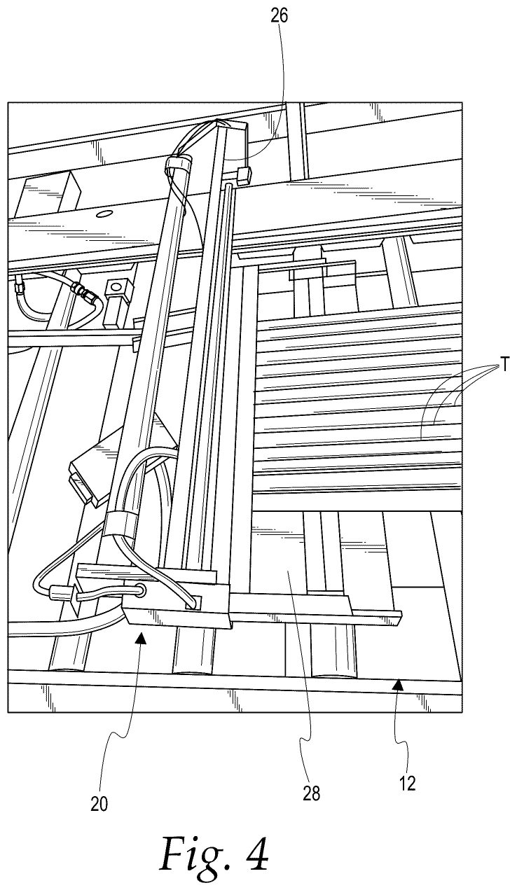

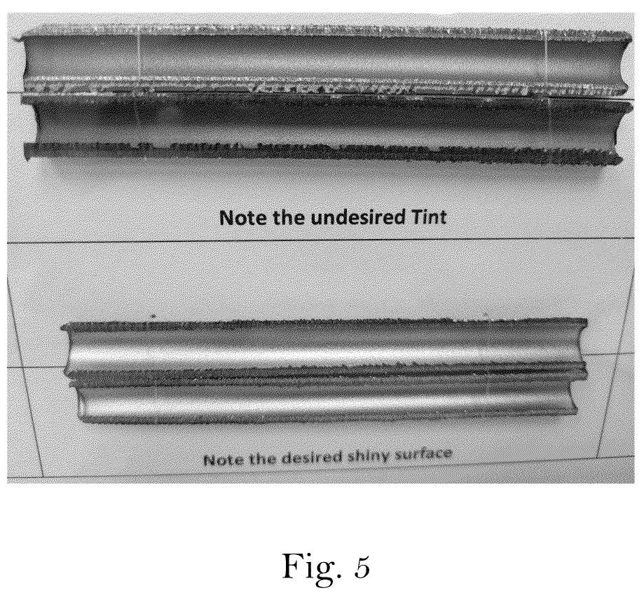

### DETAILED DESCRIPTION OF THE INVENTION

While the present invention is susceptible to embodiment in various forms, there is shown in the drawings and will hereinafter be described a presently preferred embodiment of the invention, with the understanding that the present disclosure is to be considered as an exemplification of the invention, and is not intended to limit the invention to the specific embodiment disclosed.

As will be further discussed, the present invention is directed to a system and method of operation for limited tinting and other undesired contamination of the inside surfaces of metallic tubing during heat-treatment. While the internal atmosphere of the associated heat-treatment furnace acts to limit such undesired effects on the exterior surfaces of the tubing, limiting these effects on the interior surfaces of the tubing can be problematic, particularly for tubing having relatively small inside diameters (IDs).

Significantly, the present invention acts to limit contamination of the inside tubing surfaces by purging the tubing with a protective gas, introduced through the trailing ends of the tubing, attendant to heat-treatment, with the preferred practice subsequently aspirating or drawing the internal atmosphere of the heat-treatment furnace into the leading ends of the tubing being treated therein.

The protective atmosphere may comprise nitrogen, which while technically not inert can be suitably used for many alloys since it is inert to such alloys. In some instances, the tubing is initially filled with argon (inert) but can then be filled with nitrogen (mostly inert) or even hydrogen as used in some applications where a reactive gas produces a reducing atmosphere. The furnace atmospheres pulled into the tubing can be 100% hydrogen, mixed hydrogen-nitrogen (at a full range of percentages), generated 75% hydrogen-25% nitrogen (Dissociated Ammonia), argon (for titanium), or other mixes. The present purge system can also be used on carbon steel tubing when the economics of its use make sense for specialty products.

During development of the present invention, many state-of-the-art options were considered and researched to determine if an existing solution could be automatically applied to tubes to keep the inside diameter of the tube clean and oxide free during heat treatment cycles. No available technology or method was found that considered to provide the desired results.

The internal, inert furnace atmosphere pressure and furnace curtain design, act to push the atmosphere into the tubes as they travel into the furnace to a certain degree. As the ease with which the atmosphere can flow into the tubes vs. around the tubes is reduced, the atmosphere tends to take the path of least resistance which ordinarily is around the tubes. This is especially evident in connection of relatively smaller diameter tubes.

After evaluating and exhausting other methods, it was determined that pulling or drawing furnace atmosphere into the tubes would provide the best and most consistent results, with the least disruption of the flow direction of the furnace atmosphere. It was found to be easier to control the pulling of gas through multiple tubes than trying to force the furnace atmosphere through the tubes with curtain modifications, or by blowing the furnace atmosphere through the tubes, which was found to only act upon the tubing for a short time. This approach led to the use of the furnace atmosphere itself to purge the tubes of oxygen by pulling the atmosphere into the tubes in a controlled manner.

The technique of pushing purge gases into the tubes was further considered. Improved results could be achieved from the current state-of-the-art pre-purging of the tubes, before they entered the furnace, by maintaining this purge until the tubes entered the furnace as part of the entire purge cycle. The initial study was performed using a custom-made single tube test venturi to verify if it could adequately pull the furnace atmosphere into the tubes in a controlled manner and produce a clean tube ID. Positive results from this approach were then verified by a production scale proof of concept followed by a test “sled” that could push purging gas into production quantities of tubes that were lined up to transfer into the furnace. Once inside the furnace, a vacuum was implemented to pull furnace atmosphere into the tubes. This was accomplished by use of a venturi vacuum pump to pull the atmosphere into the tubes, and a solenoid-controlled line pressure for the initial purge gas. This two-stage purge assured there would always be a beneficial atmosphere present inside the tubes during heat treatment. This system purged tubes of oxygen, moisture, and some contaminants. Further, it maintained purge gases until the leading ends of the tubes were well into the furnace where the furnace pressure was able to take over and maintain purging gas or atmosphere inside the tubes.

This two-stage redundant purge has proven to be highly successful. Thorough purging of small I.D. tubes (≤0.632″ OD) during the heat treatment cycle with minimal operator time required, has been reliably and repeatably achieved. The pre-purge is maintained by use of a “sled” that attaches to and seals around the trailing edge of the multiple tubes. This equipment allows for pre-purge pushing of gases through the tubes without the possibility of oxygen entering the tubes, and then pulling the furnace atmosphere into the tubes once the leading ends are in the furnace surrounded by the furnace protective atmosphere. The current purge device uses a programmable logic controller (PLC) to determine tube position and purge timing for consistent and safe operation.

This invention has provided the ability to purge tubes that normally wouldn't be able to have adequate purge gas or atmosphere in them due to unfavorable length or I.D. sizes. This “sled” can also be used on extremely long length tubes that have both ends of the tube outside the furnace, by using one purge sled working separately or in concert with a second sled on the other end of the tube(s).

Features of the present invention promote its efficient, cost-effective practice. Redundant purging first uses pressurized gases to fill the tubes before entering the furnace. The purge atmosphere can then be maintained so that oxygen cannot enter the tubes before entering the furnace. Thereafter, using a vacuum to pull furnace atmosphere into the tubes once the leading ends of the tubes are in the furnace desirably acts to maintain atmosphere within the tubing.

Use of a venturi as a vacuum source facilitates efficient operation. The use of a venturi vacuum is desirably straightforward, safe, and is more easily employed for mobile applications, such as a moving purge sled, than use of an electrical vacuum pump or the like. The venturi arrangement is desirably compact, and reduces the chance of failure since there are no moving parts, the furnace atmosphere is diluted coming out of the venturi, and it is fully adjustable for vacuum pressure and flow.

The present method acts to maintain the purge gases in the tubes until they are in a position for the furnace to provide enough pressure to keep oxygen out of the tubes. This is accomplished by using a purge sled that moves along with the tubes on an incoming conveyor, and by sealing the trailing ends of the tubes in the purge sled and isolating that chamber from oxygen. With the dual purge, the purge gas is held in the tubes until the pulling of furnace atmosphere into the tubes commences. The current invention also adds additional purge gas just before entering the furnace to make sure no oxygen has leaked into the end of the tube(s).

By use of the present invention, a single or dual purge of all of the tubes lined up into the furnace at once can be readily accomplished, providing a consistent purge. This operation can be timer or PLC controlled to provide even more consistency. In the current embodiment, the PLC allows for minimal operator interaction other than putting the tubes into the purge sled at the beginning of the cycle and removing the purge sled once the purging process has completed. All purging functions and timings are controlled by the PLC.

As noted, in one aspect of the invention, the method can be practiced to individually pull furnace atmosphere into the tubes once the leading ends of the tubes are past any flame and physical curtains.

By the present method, there is a large degree of flexibility for the furnace (or other heating source), the furnace atmospheres, the pre-purge gases, and the tube configurations. This invention can be scaled and configured to perform ID purging on any size or length of tube. At present, the invention has been practiced using the purge sled on all tubes ≤0.632″ OD's.

While the present invention is particularly effective for treatment of small ID tubes, the invention can be used on larger ID tubes of any length. Further, it can be used to maintain atmosphere for tubes that extend through a furnace on either end, or where the ends of the tubes are at a higher pressure than what is in the furnace (such as in a windy/drafty area). Notably, this invention can be used where furnace atmosphere is insufficient to overcome conditions external to the furnace.

It is within the purview of the present invention that two purge devices can be used on extremely long tubes to maintain purging. One such purge device can be used as tubes go in the furnace, with the purging atmosphere maintained as tubes are exiting the furnace by switching over to a second purging device to maintain an atmosphere for entire heating cycle, regardless of tube length. This method can also be used on processes such as induction hardening or annealing to maintain atmosphere in the ID's during the entirety of its process. If desired, one device can be used for moving from the entrance end of tubes to the exiting end of tubes.

Modifications to the current embodiment can be made to pull cleaning solutions, rinse solutions, pickling solutions, passivating solutions, etc. through tubes-which can be particularly desirable for difficult-to-process small ID tubes.

In a current embodiment of the present invention, the purge sled is configured to readily receive the trailing ends of the tubing being heat-treated, and to seal the ends in substantially gas-tight relationship with the gas chamber of the sled. To this end, the purge sled has a clam-shell like configuration that includes a hingedly movable upper jaw element which is movable into confronting relationship with a lower jaw element. Cooperating elastomeric surfaces are provided on the jaw elements so that the ends of the tubing to be treated can be placed on the lower jaw element, and the upper jaw element closed so that the cooperating elastomeric surfaces seal the tubing for communication with the gas chamber of the purge sled. Use of layers of closed cell and open cell foam on each of the jaws has been effective, with the open cell foam provided at the inner, confronting surfaces of the jaws for contact with the tubing being treated. Use of a closed-cell foam has been found to provide desired durability and stiffness, with use of an open-cell foam on the found to provide the desired sealing of the tubing while exhibiting sufficient resilience to substantially return to its initial shape after use, enhancing thorough sealing around the tubing. This arrangement provided durability with the closed cell foam, with resilient “spring-back” memory open cell foam, which desirably kept the foam from taking a “set” from the tubes. It was found that if the foam kept the shape of the tube, then subsequent sealing would be prone to excessive leaking.

Notably, the use of a programmable logic controller (PLC) promotes efficient operation. In particular, the present method contemplates monitoring and measuring pressure within the gas chamber of the purge sled to ascertain that the gas chamber is sufficiently sealed to the trailing ends of the metallic tubes. Additionally, the flow of inert gas into the gas chamber of the purge sled is monitored to ascertain that there is a sufficient flow of inert gas for performing purging of the interiors of the metallic tubes. The pressure of compressed air provided for creating the venturi employed for creating the vacuum within the gas chamber of the purge sled is also monitored by the controls to assure that sufficient vacuum is created to draw the atmosphere within the heat-treatment furnace into the tubing, during the contemplated “second purge”, that is, after inert gas is initially forced into the tubing from the gas chamber.

By virtue of the automation to which the method lends itself, there is a reduced chance of operator error due to PLC and one button operation. Moreover, self-diagnostics of the purge system can be performed to assure necessary gas pressures are maintained and assure there is no degradation of the sealing components. In the current embodiment, purging gas pressure is verified, compressed air used for the vacuum venturi is verified, the solenoid isolating the purge chamber so that purge gas is forced through the tubes is verified along with the purge chamber seals. The process is PLC controlled and tube purging cannot proceed without passing all the tests.

During the course of development, use of an upgraded PLC facilitated integration of more inputs and outputs, with indicator lights showing operators the performance and status of the heat-treatment process. Upgrades to the timing functions for pushing argon and pulling furnace atmosphere were effected after “borderline” results on some relatively longer cut tubes (mostly effective except for longer tubes if there is marginal argon or air pressure). The upgraded PLC has allowed for adding diagnostic functions necessary for consistently purged tubing.

A manometer was added for an operator to manually test the purge sled of inches of water column when pressurized with factory supplied argon. In a later embodiment, this manometer was incorporated into the purge sled with an automatic diagnostic feature to check if the sled has sufficient argon pressure inside the sled. Notably, the sled's diagnostic capability has lead to decreased operator error during system operation.

With reference now to the drawings, therein is illustration a heat-treating system for practice the present invention. As illustrated, the present method is practiced in connection with a heat-treatment furnace 10, into which metallic tubes or tubing, designated T, is advanced for effecting heat-treatment. To this end, a conveyor 12 extends into the heat-treatment furnace 10, with the tubing T conveyed and advanced into the furnace on the conveyor 12.

In accordance with the present invention, the present method of heat-treating tubing comprises the steps of providing a heat-treatment furnace 10 having a controlled internal atmosphere, and providing one or more metallic tubes T for heat-treatment. Notably, the present method contemplates that a purge sled 20 is provided, wherein the purge sled has a gas chamber, generally designated 24, for receiving a trailing end of each of the metallic tubes T.

The trailing end of each metallic tube T is sealed in gas-tight relationship with the gas chamber of said purge sled for control of the atmosphere within the metallic tubes. To this end, the purge sled 20 has a clam-shell like configuration, including upper and lower jaws 26, 28 between which the trailing ends of tubes T are positioned for treatment. The surfaces of the upper and lower jaws are provided with elastomeric material to provide a substantially gas-tight fit with the tubing when the upper and lower jaws 26, 28 of the purge sled 20 are closed, thereby closing the gas chamber 24 of the purge sled, and joining the tubes in fluid communication with gas chamber 20.

In order to purge the interior of the tubing being heat-treated, the gas chamber 24 of the purge sled 20 is pressurized with a protective atmosphere such as an inert gas to thereby purge the inside diameter of each of the metallic tubes. The protective atmosphere desirably acts to minimize oxidation or degradation of the inside diameter of each of the metallic tubes T. The purging of the tubing T is maintained while advancing the purge sled, 20, to thereby advance the metallic tubes into the heat-treatment furnace 10 by the conveyor 12.

Effectiveness is enhanced by measuring pressure within the gas chamber 24 of the purge sled 20 to ascertain that the gas chamber is sufficiently sealed at the upper and lower jaws 26, 28 to the trailing ends of the metallic tubes T to purge the inside diameter of each one of the metallic tubes. Desirably, the present method can be operated to purge the inside diameter of the tubing with minimal disruption to the normal balance and flow of atmosphere gases at the entry and exit of the heat-treatment furnace.

It is within the purview of the present invention to further control the atmosphere within the metallic tubing by providing another purge sled for operative connection with the leading ends of the tubes T be treated. This further purge sled can be configured like the illustrated purge sled 20, with a gas chamber within the further sled be operated to maintain the desired atmosphere within the tubes T as the tubes move out from within the atmosphere of the heat-treating furnace 10.

Notably, in the preferred practice of the present invention, purging of the tubing T can be enhanced by creating a vacuum within the gas chamber 24 of the purge sled 20. This acts to aspirate and thereby draw the controlled internal atmosphere of the heat-treating furnace 10 into a leading end of each of the metallic tubes T, and into the inside diameter of each said metallic tube. Notably, this step of creating a vacuum within the gas chamber of the purge sled includes creating a venturi, with compressed air, to generate a vacuum within the gas chamber of the sled.

The effectiveness of the present method is enhanced by monitoring pressure of compressed air for creating the venturi effect, to thereby determine that sufficient gas pressure exists to create the venturi effect with sufficient vacuum to aspirate and draw the controlled internal atmosphere of the heat-treatment furnace into the inside diameter of each one of the metallic tubes. It has been found that effectiveness is further enhanced by providing an accumulator tank for creating the venturi for consistent vacuum operation, and reduce restrictions in the protective gas lines for improved flow which reduced the pressure drop during the purging cycle.

Efficient operation is further promoted by: (1) determining variations in the lengths of the metallic tubes to ensure sufficient purging of longer ones of said metallic tubes; (2) determining the internal diameter of the metallic tubes to ensure sufficient purging of longer and smaller diameter ones of and metallic tube; and (3) monitoring the number of the metallic tubes subject to purging to evaluate overall heat-treatment production.

In the preferred practice, the present method includes providing a pair of spaced apart sensors that are provided to determine if the metallic tubes T are present, and if the metallic tubes are starting in or going out of the sensor zone, and to further determine the speed at which the tubes are advanced into the heat-treatment furnace 10. To this end, two light curtains 30, 32 are employed for the logic controller for “seeing” if tubes are present, and if they are starting in or going out of the sensor zone. These sensors also to obtain timing to determine how fast the conveyor 12 advancing the tubing T is running. This is important for determining when the system is operated for pulling of the furnace atmosphere into the tubes, to avoid drawing air, and flame, in addition to hydrogen into the purge chamber. This speed timing can also be provided by the PLC employed for operating the heat-treatment furnace.

As noted, during invention development applicants investigated previous arrangements for effecting purging of metallic tubing during heat-treatment. It is believed that originally “rubber cup” purging of three to five tubes at a time with Argon for 7 seconds was effected, outside of the associated furnace. The tubes were then run into the furnace once all tubes were purged. This is believed to have allowed operator to miss purging tubes, with possible distractions occurring as operators worked through the fifteen to thirty tubes that need to be purged. Also, it will be appreciated that the first tubes purged would sit out much longer before going into the furnace. Experience has shown this previous technique required a large amount operator time, was thusly relatively inefficient, and wasn't consistently effective. It is believed that if operators purged some tubes and were then interrupted, they might not have necessarily purged those tubes again.

While investigation show this technique was modified to increase purging time to twenty-eight seconds, but this did not address the various short-comings of the practice. It is believed problems persisted with operators missing tubes, and the gap between the first tubes being purged to last tubes being purged was longer and more operator time was needed.

During development of the present invention, it was determined that improved results could be achieved by decreasing the volume of the gas chamber within the purge sled, while providing enhanced sealing between the jaws of the purge sled and the trailing ends of the tubes being treated. The illustrated, clam-shell like configuration of the purge sled 20 was found to facilitate operator use, enhanced automatic control features incorporated in the PLC providing more consistent and reliable results. Notably, the PLC was upgraded to better handle the timing functions of the controls, and allow for diagnostic functions.

An important improvement to the system made during development was the addition of pressure sensors for measuring gas pressure within the gas chamber 24 of the purge sled 20. This was found to be important for consistently providing tubing free of tinting.

Measurement of gas pressures inside the purge sled chamber identified issues with consistency of sealing from one load of tubes to the next, and inconsistent argon and air pressures during purging cycles. Prior to the provision of a sensor for measuring pressure with the purge sled chamber, there was no way to verify that all the tubing seals were in place and/or in good condition, that there was sufficient air pressure throughout the cycle, and that there was sufficient argon (i.e., protective atmosphere pressure). The drawbacks prevented operation of the system for production without significant, time-consuming and costly testing of tubes.

To address these issues the addition of the pressure sensor to the gas chamber of purge sled permitted the purge system to ‘self-diagnose’ and verify all the tubing seals are in good condition, and that argon and air pressures are at the proper levels prior to letting the operator run the purge cycle. From testing, it was determined that it was necessary to change some of the sealing foam that seals around the tube because it would not recover its shape between loads of tubes being run. Use of an open cell foam, which more readily recovers its form between loads of tubes being run, was determined to address this issue. It was additionally determined that sealing of the side faces of this foam was necessary for appropriate function.

The addition of an accumulator tank for the compressed air was found to provide consistent vacuum operation, and reduce the restrictions in the argon lines for improved flow which reduced the pressure drop during the purging cycle. Other modifications have included using foam sealing modules that operators can readily change out, rather than requiring engineering or maintenance. The capability to readily switch foam sealing element desirably allows installation of foam seal of differing thicknesses to permit treatment of multiple layers of tubes in the purge sled with sealing between them.

For all the additional functionality of the purge system, the purge system PLC was upgraded. Included in the upgrades were diagnostics as mentioned, which check argon pressure, air pressure, and chamber pressure during a diagnostics cycle that must run prior to allowing the system to go into the purge cycle, continuous monitoring of argon and air pressure during the cycle, indications if there was a failure at any time during the cycle, indication if the diagnostics pass but getting marginal readings. Also added is a ‘mixed tube length’ cycle if the tubes lengths are uneven enough that not all of the leading ends would be in the furnace prior to pulling furnace atmosphere into the tubes, and a ‘long tube’ cycle that increases the purge times for long small ID tubes.

The use of a pair of spaced apart sensors in the form of the two light curtains for the logic controller, act to “see” if tubes are present and if they are starting in or going out of the sensor zone, but also to get timing to determine how fast the conveyor belt 12 is running. As noted, this is required to determine when to initiate the pulling of the furnace atmosphere into the tubes to avoid pulling air, and/or flame, in addition to hydrogen into the purge gas chamber of the purge sled. Alternatively, the desired speed timing can be provided to the PLC from the main PLC of the heat-treatment furnace.

Significantly, scanning electron microscopy (SEM) analysis on the tinted and non-tinted stainless steel show provided conclusive proof that purging oxygen from inside the of the tubes just prior to going inside the Brite Anneal furnace for annealing would dramatically decrease the amount of chrome oxide forming on the inner walls.

The introduction an upgraded PLC better able to handle more operations and added input/output cards to permit the purge system to automatically diagnose itself, including checking to determine if argon is present, compressed air is present, and to test the seals in the gas chamber of the purge sled. Additional testing continues, including datalogging of the sled sensors to be able “look back” and identify any performance issues. The system is provided with operational modes for handling longer tubes, with extended time for each purge being evaluated. Also being investigated is the addition of an operational mode for safe purging of mixed length tubes.

The end goal of the present invention is to avoid cutting, and destroying, one tube per layer or bundle (typically two layers) to verify that purging was effective, while handing all lengths of tubes as well as mixed length tubes. The present invention seeks to improve upon and render unnecessary previous efforts that have been made to reduce tinting, while reducing required overall monitoring of the purging process, the process being suitable for use under typical production and maintenance operations.

From the foregoing, it will be readily apparent that numerous modifications and variations can be effected without departing from the true spirit and scope of the present invention. The disclosure is intended to cover, by the appended claims, as such modifications that fall within the scope of the claims.

What is claimed is:

1. A method of heat-treating tubing, comprising the steps of:
providing a heat-treatment furnace having a controlled internal atmosphere; providing one or more metallic tubes;
providing a purge sled having a gas chamber for receiving a trailing end of each said metallic tube, and sealing the trailing end of each said metallic tube in gastight relationship with said gas chamber of said purge sled; and
pressurizing said gas chamber of said purge sled to purge the inside diameter of each said metallic tube with a protective atmosphere in order to minimize oxidation or degradation of the inside diameter of each said metallic tube, and advancing said purge sled to advance said metallic tubes into said heat-treatment furnace while maintaining the protective atmosphere in the tubes during heat-treatment.

2. A method of heat-treating tubing in accordance with claim 1, including
creating a vacuum within said gas chamber of said purge sled after said pressurizing step to thereby draw the controlled internal atmosphere of said heat-treating furnace into a leading end of each metallic tube and into the inside diameter of each said metallic tube.

3. A method of heat-treating tubing in accordance with claim 2, wherein said step of creating a vacuum within said gas chamber includes creating a venturi to generate a vacuum within said gas chamber of said purge sled.

4. A method of heat-treating tubing in accordance with claim 3, including
monitoring pressure of compressed air for creating said venturi to create the vacuum within said gas chamber of said purge sled to determine that sufficient gas pressure exists to create said venturi with sufficient vacuum to draw said controlled internal atmosphere of said heat-treatment furnace into the inside diameter of each one of said metallic tubes.

5. A method of heat-treating tubing in accordance with claim 3, including
providing an accumulator tank for creating the venturi for consistent vacuum operation.

6. A method of heat-treating tubing in accordance with claim 1, including
providing another purge sled, and sealing the leading end of each of said tubes to a gas chamber thereof for further controlling the atmosphere with said metallic tubes.

7. A method heat-treating tubing in accordance with claim 1, including
monitoring pressure within said gas chamber of said purge sled to ascertain that said gas chamber is sufficiently sealed to the trailing ends of said metallic tubes to purge the inside diameter of each one of said metallic tubes.

8. A method of heat-treating tubing in accordance with claim 1, including
monitoring flow of the protective atmosphere into said gas chamber of said purge sled to ascertain sufficient flow of inert gas for performing purging of the interiors of said metallic tubes.

9. A method of heat-treating tubing in accordance with claim 1, including
purging the inside diameter of the tubing with minimal disruption to the normal balance and flow of atmosphere gases at the entry and exit of the heat-treatment furnace.

10. A method of heat-treating tubing in accordance with claim 1, including
determining variations in the lengths of said metallic tubes to ensure sufficient purging of longer ones of said metallic tubes.

11. A method of heat-treating tubing in accordance with claim 12, including
determining the internal diameter of said metallic tubes to ensure sufficient purging of longer and smaller diameter ones of said metallic tubes.

12. A method of heat-treating tubing in accordance with claim 1, including
monitoring the number of said metallic tubes subject to purging to evaluate overall heat-treatment production.

13. A method of heat-treating tubing in accordance with claim 1, including
providing a pair of spaced apart sensors to determine if said metallic tubes are present, and if the metallic tubes are starting in or going out of the sensor zone, and to further determine the speed at which the tubes are advanced into said heat-treatment furnace.
